(19) United States
(12) Patent Application Publication
(10) Pub. No.: US 2018/0314008 A1
(43) Pub. Date: Nov. 1, 2018

(54) OPTICAL COMMUNICATION SYSTEM AND METHOD OF MULTI-CHANNEL OPTICAL TRANSMISSION AND RECEPTION

(71) Applicant: National Taiwan University of Science and Technology, Taipei (TW)

(72) Inventor: San-Liang Lee, Taipei (TW)

(73) Assignee: National Taiwan University of Science and Technology, Taipei (TW)

(21) Appl. No.: 15/682,559

(22) Filed: Aug. 22, 2017

(30) Foreign Application Priority Data
Apr. 28, 2017 (TW) 106114298

(51) Int. Cl. G02B 6/293; H04J 14/02; H04B 10/50; H04B 10/572

(52) U.S. Cl. CPC G02B 6/29398; H04J 14/0282; G02B 6/2938; H04B 10/572; H04B 10/503; H04B 10/506; G02B 6/29395

(57) ABSTRACT

An optical communication system and multi-channel optical transmission and reception methods are provided. A transmitter of the optical communication system includes N laser source arrays, N sub-channel couplers, and a CWDM multiplexer. Each of the laser source arrays corresponds to a CWDM wavelength channel location and outputs M sub-channel light sources corresponding to M sub-wavelength channel locations at a CWDM wavelength channel location. The N sub-channel couplers are coupled to the N laser source arrays in a one-to-one manner. Each of the sub-channel couplers respectively receives the M sub-channel light sources of the corresponding laser source array and exports the M sub-channel light sources into a same output port. The CWDM multiplexer is coupled to the N sub-channel couplers to receive output signals of the N sub-channel couplers, to combine the N output signals into a light signal, and to output the light signal to an optical fiber.

### CROSS-REFERENCE TO RELATED APPLICATION

This application claims the priority benefit of Taiwan application serial no. 106114298, filed on Apr. 28, 2017. The entirety of the above-mentioned patent application is hereby incorporated by reference herein and made a part of this specification.

### BACKGROUND OF THE INVENTION

### Field of the Invention

The invention relates to multi-channel optical transmission and reception methods, and in particular, an optical communication system and multi-channel optical transmission and reception methods.

### Description of Related Art

In optical communication technology, multi-channel signals are commonly transmitted in an optical fiber through wavelength division multiplexing (WDM). Namely, in each channel, a light source transmission signal of a different wavelength is adopted. The transmission involves distributing various signal sources on each of the wavelengths, integrating them in an optical fiber through multiplexing for transmission to a remote receiving station, and obtaining an original signal after performing demultiplexing. Accordingly, a transmission capacity is increased in the same space of the same optical fiber, which greatly enhanced a capacity and rate of information transmission.

Based on a spacing between wavelength channels, the more commonly used wavelength division multiplexing methods include coarse wavelength division multiplexing (CWDM) and dense wavelength division multiplexing (DWDM). Referring to FIG. 1A, FIG. 1A illustrates a conventional CWDM transmission system. As shown in FIG. 1A, a channel spacing of CWDM is usually set as 20 nm, and one optical fiber can accommodate at most 16 to 18 channels in its low-loss wavelength window. With an large channel spacing, this type of communication exhibits excellent wavelength drift tolerance for laser sources and does not require additional temperature control and wavelength control costs. In this sense, it is an economical and effective signal transmission method. Referring to FIG. 1B, FIG. 1B illustrates a conventional DWDM transmission system. As shown in FIG. 1B, a channel spacing commonly adopted in DWDM is 0.4 nm or 0.8 nm (sometimes a channel spacing of 0.2 nm or 1.6 nm is adopted), and hundreds or even thousands of wavelength channels can be transmitted on one optical fiber. This type of communication requires precise and stable control over output wavelengths of laser sources. The relevant control circuits are not only more complex, but also less tolerate to wavelength error, which leads to low yield in manufacturing the light sources. Therefore, the price of a DWDM module and the maintenance costs of a DWDM system are typically much higher than those of a CWDM system.

On the other hand, as the data rate of next-generation passive optical networks (PON) and optical interconnects is expected to be pushed to 100 Gb/s to even beyond Tb/s. The current 100 Gb/s Ethernet adopts the local area network wavelength division multiplexing (LAN-WDM) standard for channel wavelengths. This standard is a compromise between the range of wavelengths available and the tolerance for light source wavelengths, so a wavelength spacing between CWDM and DWDM (with a channel frequency spacing of 800 GHz and four wavelengths in total) is adopted. However, when this wavelength spacing is adopted, the temperature of light sources shall still be adequately controlled, which results in an increase in energy consumption. The latest trend of development is adopting the CWDM channel specification, mainly considering quality of the light sources and lowering the complexity and energy consumption of wavelength control. It follows that the CWDM technique having a greater wavelength spacing exhibits obvious advantages in the costs of optical transceiving modules and energy-saving performance.

From the foregoing change in the ethernet of 100 Gb/s, it is learned that the CWDM technique exhibits obvious advantages in reducing the cost and power consumption of optical transceiver modules. However, since the wavelength spacing of CWDM channels is greater, the number of channels that can be used in the range of optical communication wavelengths available is smaller. For example, in the ethernet of 100 Gb/s, the CWDM channels currently adopt four wavelengths including 1270, 1290, 1310, and 1330 nm, which already use up all of the CWDM wavelengths available close to 1300 nm. When the transmission rate is to be further increased by increasing the number of wavelength channels, there will be limitations if the CWDM technique is adopted.

In other words, it is one of the issues attracting attention from people skilled in the art how to develop a multi-channel transmission method that takes into account the costs of optical transceiving modules and power consumption but can still increase a capacity and rate of information transmission.

### SUMMARY OF THE INVENTION

In light of the above, the invention provides an optical communication system and multi-channel optical transmission and reception methods that not only maintain an advantage that it is not necessary to control a temperature of CWDM channel light sources, but also achieve the purpose of improving a capacity and rate of information transmission through increasing a number of wavelength channels.

The invention provides an optical communication system including a transmitter and a receiver. The transmitter includes N laser source arrays, N sub-channel couplers, and a CWDM multiplexer. Each of the laser source arrays corresponds to a CWDM wavelength channel location and outputs M sub-channel light sources corresponding to M sub-wavelength channel locations at a CWDM wavelength channel location, wherein M is a natural number of at least 2 and N is a natural number of at least 1. The N sub-channel couplers are coupled to the N laser source arrays in a one-to-one manner, and each of the sub-channel couplers respectively receives the M sub-channel light sources of the corresponding laser source array and exports the M sub-channel light sources into a same output port. A CWDM multiplexer is coupled to each of the sub-channel couplers to receive an output signal of each of the sub-channel couplers, to combine the N output signals into a light signal, and to output the light signal to an optical fiber. The receiver includes a CWDM demultiplexer and N sub-channel demultiplexing filters. The CWDM demultiplexer receives the light signal from the optical fiber, and divides the light signal into N CWDM group channels according to the N CWDM wavelength channel locations. Each of the sub-channel demultiplexing filters is coupled to the CWDM demultiplexer. The N sub-channel demultiplexing filters receive the N CWDM group channels in a one-to-one manner. Each of the sub-channel demultiplexing filters is configured to separate the CWDM group channels into M recovered sub-channel light signals corresponding to the M sub-wavelength channel locations.

In an embodiment of the invention, a wavelength spacing between the M sub-wavelength channel locations is smaller than a wavelength spacing between the N CWDM wavelength channel locations.

In an embodiment of the invention, there is a fixed wavelength spacing between the M sub-wavelength channel locations.

In an embodiment of the invention, the M sub-wavelength channel locations of the transmitter drift due to a change in an environmental temperature. Each of the sub-channel demultiplexing filters of the receiver is further configured to track the M sub-wavelength channel locations in the CWDM group channels and individually adjust central wavelength locations to the M sub-wavelength channel locations, and separate the CWDM group channels into M recovered sub-channel light signals corresponding to the M sub-wavelength channel locations.

In an embodiment of the invention, the optical communication system further includes N optical receivers. The N optical receivers are coupled to the N sub-channel demultiplexing filters in a one-to-one manner, and each of the optical receivers respectively receives the M recovered sub-channel light signals of the corresponding sub-channel demultiplexing filter.

The invention provides a multi-channel optical transmission method applicable to an optical communication system. The method includes the following steps: outputting M sub-channel light sources corresponding to M sub-wavelength channel locations respectively at N CWDM wavelength channel locations, wherein M is a natural number of at least 2 and N is a natural number of at least 1; exporting each of the M sub-channel light sources respectively into a same output port; and combining N output signals of the N output ports into a light signal, and outputting the light signal to an optical fiber.

In an embodiment of the invention, a wavelength spacing between the M sub-wavelength channel locations is smaller than a wavelength spacing between the N CWDM wavelength channel locations.

In an embodiment of the invention, there is a fixed wavelength spacing between the M sub-wavelength channel locations.

The invention provides a multi-channel optical reception method applicable to an optical communication system. The method includes the following steps: dividing a light signal received from an optical fiber into N CWDM group channels according to N CWDM wavelength channel locations; and separating each of the CWDM group channels into M sub-channel light sources corresponding to M sub-wavelength channel locations, wherein M is a natural number of at least 2, N is a natural number of at least 1 and there is a fixed wavelength spacing between the M sub-wavelength channel locations.

In light of the above, the embodiments of the invention provide an optical communication system and multi-channel optical transmission and reception methods. In the transmitter of the optical communication system, a plurality of light sources of different wavelengths close to one single CWDM channel are packaged into one single carrier or are integrated on one single substrate, so that they exhibit similar amounts of wavelength drift with respect to a change in the environmental temperature without having to control a temperature. Moreover, the receiver of the optical communication system adopts the demultiplexing filters that can track wavelength locations. Accordingly, when a wavelength drift arises in each of the wavelength channels due to influence of the environmental temperature or component performance aging, the signals can still be effectively demultiplexed and respectively received. Hence, by enabling the channel locations at the original CWDM, the optical communication system of the invention increases the number of channels that can actually be transmitted and the capacity of data that can be transmitted. Moreover, while the advantage that it is not necessary to control the temperature of the CWDM channel light sources is maintained, complexity of transceiving modules is significantly simplified and manufacturing and maintenance costs are lowered.

To provide a further understanding of the aforementioned and other features and advantages of the invention, exemplary embodiments, together with the reference drawings, are described in detail below.

### BRIEF DESCRIPTION OF THE DRAWINGS

FIG. 1A illustrates a conventional CWDM transmission system.

FIG. 1B illustrates a conventional DWDM transmission system.

FIG. 2A is a conceptual schematic diagram illustrating an allocation of sub-wavelength channels based on CWDM channels according to an embodiment of the invention.

FIG. 2B is a conceptual schematic diagram illustrating sub-wavelength channel tracking according to an embodiment of the invention.

FIG. 3 illustrates a system framework diagram of an optical communication system according to an embodiment of the invention.

FIG. 4 illustrates a system framework diagram of an optical communication system embodiment including 4 laser source arrays each of which is a dual-wavelength laser source according to FIG. 3.

FIG. 5 is a schematic diagram illustrating a sub-channel demultiplexing filter according to FIG. 4.

FIG. 6 is a flowchart illustrating a multi-channel optical transmission method according to an embodiment of the invention.

FIG. 7 is a flowchart illustrating a multi-channel optical reception method according to an embodiment of the invention.

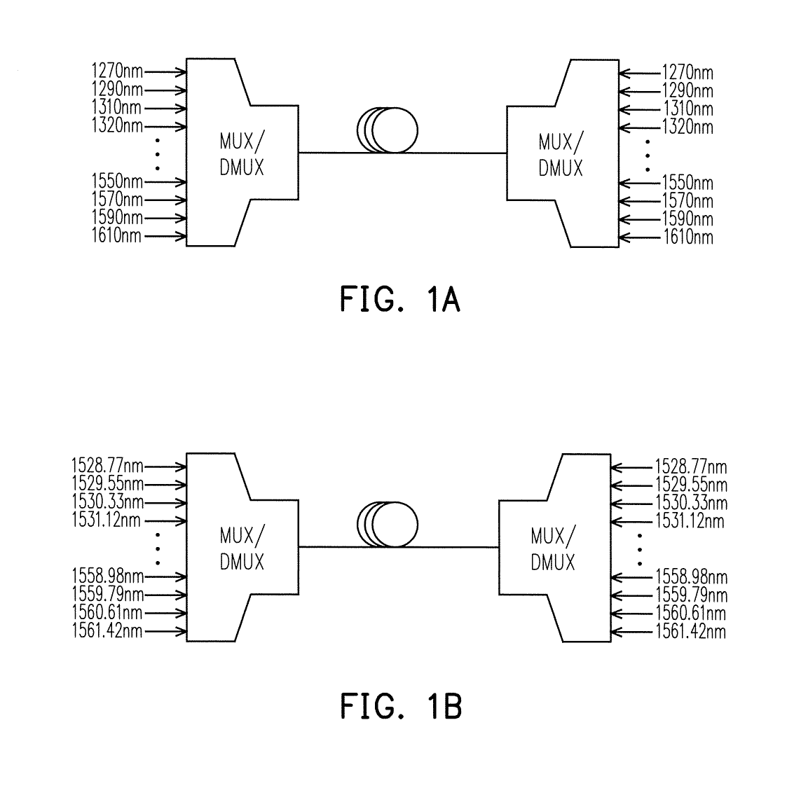

### DESCRIPTION OF THE EMBODIMENTS

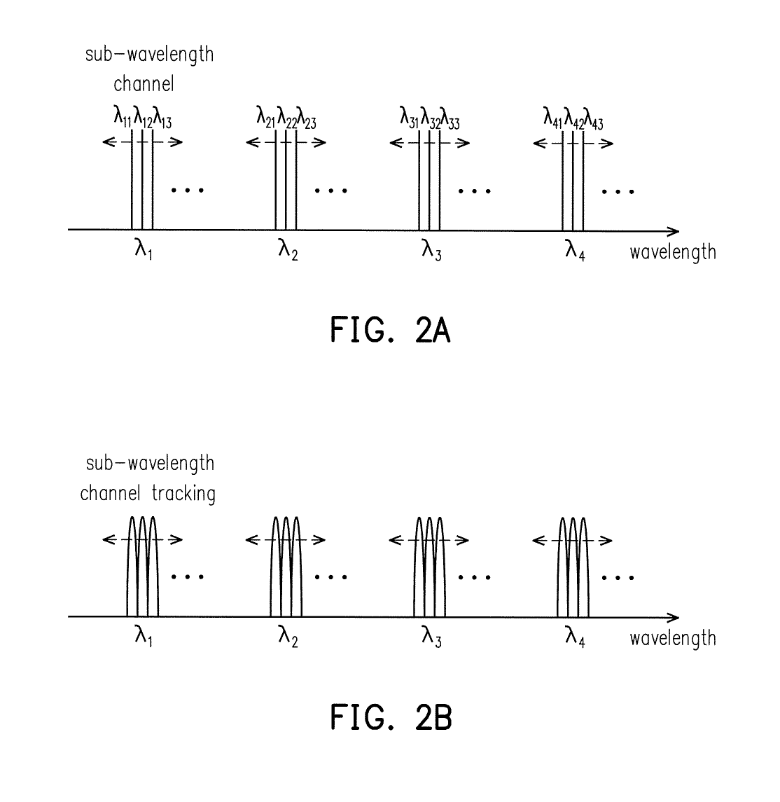

First, the present embodiment of the invention simultaneously providing a number of sub-wavelength channels of a smaller wavelength spacing at each CWDM channel in order to increase a number of CWDM wavelength channels. FIG. 2A is a conceptual schematic diagram illustrating an allocation of sub-wavelength channels based on CWDM channels according to an embodiment of the invention. Referring to FIG. 2A, wavelengths λ₁, λ₂, λ₃, λ₄, . . . are wavelengths adopted in CWDM channels. In the present embodiment of the invention, sub-wavelength channels having wavelengths of λ₁₁, λ₁₂, λ₁₃, . . . are provided at a channel location of the wavelength λ₁; sub-wavelength channels having wavelengths of λ₂₁, λ₂₂, λ₂₃, . . . are provided at a channel location of the wavelength λ₂; sub-wavelength channels having wavelengths of λ₃₁, λ₃₂, λ₃₃, . . . are provided at a channel location of the wavelength λ₃; and sub-wavelength channels having wavelengths of λ₄₁, λ₄₂, λ₄₃, . . . are provided at a channel location of the wavelength λ₄, and so on.

To maintain the advantage that it is not necessary to control a temperature of CWDM channel light sources and to ensure that signals can still be effectively demultiplexed and respectively received when a wavelength drift arises in the wavelength channels due to influence of an environmental temperature, a fixed wavelength spacing needs to be provided between the sub-wavelength channels. In light of the above, when the wavelength drift arises in the wavelength channels due to influence of the environmental temperature, the sub-wavelengths in each set of the CWDM wavelength channels are changed as an entire set by a same proportion. In other words, an amount of wavelength drift of the sub-wavelength channels in each set of the wavelength channels is approximately identical.

In this situation, FIG. 2B is a conceptual schematic diagram illustrating sub-wavelength channel tracking according to an embodiment of the invention. In each set of the CWDM wavelength channels at a receiver, a wavelength tracker is respectively used to sequentially track locations of the sub-wavelength channels. Demultiplexing locations of the wavelength tracker are accordingly adjusted to separate the sub-wavelength channels to individually perform signal reception. It shall be mentioned that with respect to the sub-wavelength channels in any one set of the CWDM wavelength channels, since the fixed wavelength spacing is provided between each of the sub-wavelength channels, in the situation where any one sub-wavelength channel location has been tracked in any one set of the CWDM wavelength channels, the rest of the sub-wavelength channel locations in the same CWDM wavelength channel are further demultiplexed through the tracked sub-wavelength channel location.

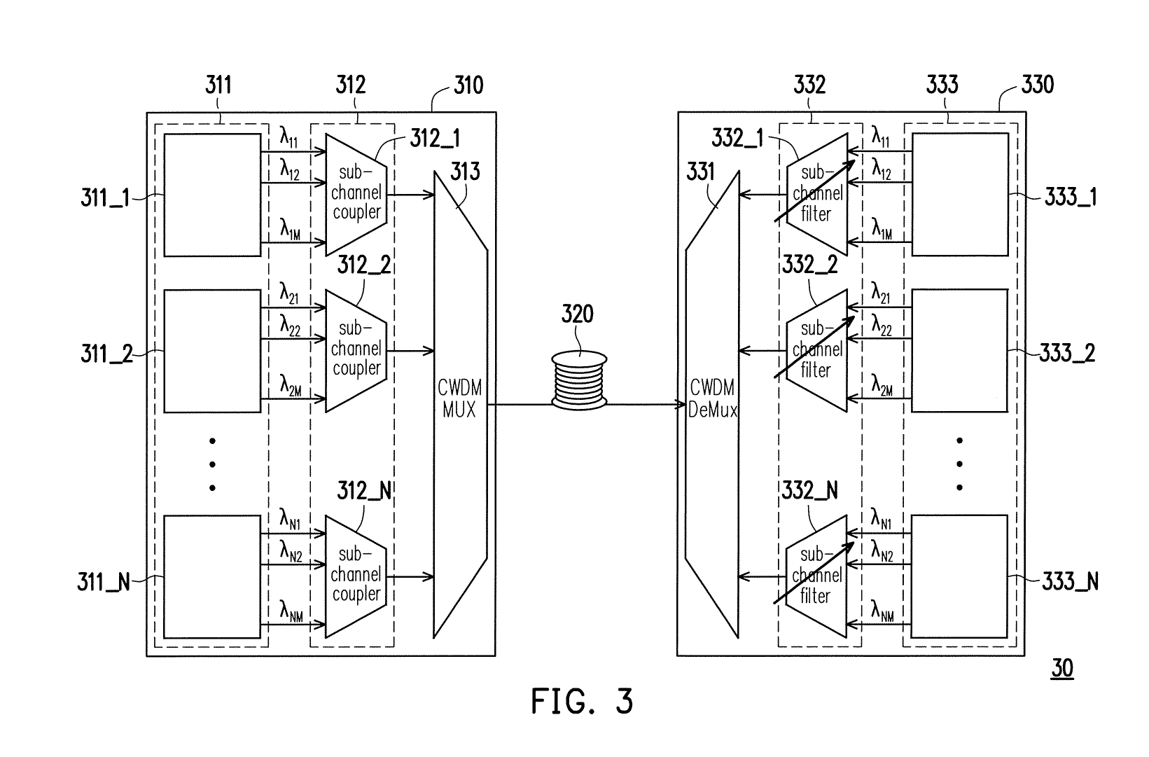

Based on the foregoing concept, FIG. 3 illustrates a system framework diagram of an optical communication system according to an embodiment of the invention. Referring to FIG. 3, an optical communication system 30 includes a transmitter 310, an optical fiber 320, and a receiver 330. The transmitter 310 and the receiver 330 are constituted by physical circuits. The transmitter 310 and the receiver 330 are coupled with each other via the optical fiber 320. The transmitter 310 transmits a light signal to the optical fiber 320, and the receiver 330 receives the light signal from the optical fiber 320. In the present embodiment, the optical fiber 320 is a single mode fiber (SMF) or a multimode fiber (MMF), but the invention is not limited hereto. Moreover, the optical communication system 30 of the present embodiment adopts, for example, a passive optical fiber network framework, but the invention is not limited hereto. In other embodiments, an optical fiber network framework of another type may also be adopted.

The transmitter 310 includes a light source module 311, a sub-channel coupling module 312, and a CWDM multiplexer 313.

In the present embodiment, based on the concept of providing a number of adjacent sub-wavelength channels of a smaller channel spacing in the CWDM wavelength channel, the light source module 311 includes N laser source arrays (i.e., laser source arrays 311_1, 311_2, . . . , 311_N) respectively corresponding to respective CWDM wavelength channel locations. Moreover, each of the laser source arrays at each of the CWDM wavelength channel locations is configured to respectively output M sub-channel light sources corresponding to M sub-wavelength channel locations. For example, supposing that the laser source array 311_1 corresponds to the CWDM channel location of the wavelength λ₁ in FIG. 2, then the laser source array 311_1 outputs the M sub-channel light sources having a smaller wavelength spacing at the CWDM channel of the wavelength λ₁, respectively at channel locations having wavelengths of λ₁₁, λ₁₂, . . . , λ_{1M}. Similarly, it is inferred that the rest of the laser source arrays 311_2, . . . , 311_N also respectively output the M sub-channel light sources having a smaller wavelength spacing at other CWDM channels. It shall be noted that the wavelength spacing between the M sub-wavelength channel locations is smaller than the wavelength spacing between the N CWDM wavelength channel locations. Moreover, there is a fixed wavelength spacing between the M sub-wavelength channel locations. In addition, the N CWDM wavelength channel locations do not overlap. Furthermore, the M is a natural number of at least 2 to conform to the concept of providing a number of sub-wavelength channels having a smaller channel spacing in one wavelength channel. However, in actual situations, the M sub-channel light sources may be integrally packaged on one single module or be manufactured into a multiwavelength light source array chip through integration techniques.

The sub-channel coupling module 312 includes N sub-channel couplers (i.e., sub-channel couplers 312_1, 312_2, . . . , 312_N) coupled to the N laser source arrays in the light source module 311 in a one-to-one manner to receive the M sub-channel light sources of the corresponding laser source arrays and export the M sub-channel light sources into a same output port.

The CWDM multiplexer (CWDM MUX) 313 is coupled to the N sub-channel couplers to receive output signals of all of the sub-channel couplers, to combine the output signals of all of the sub-channel couplers into a light signal, and to output the light signal to the optical fiber 320.

On the other hand, the receiver 330 includes a CWDM demultiplexer 331, a sub-channel demultiplexing filter circuit module 332, and a light reception module 333.

The CWDM demultiplexer (CWDM DeMux) 331 receives the light signal from the optical fiber 320 and divides the light signal into N CWDM group channels according to the N CWDM wavelength channel locations.

The sub-channel demultiplexing filter circuit module 332 is coupled to the CWDM demultiplexer 331. The sub-channel demultiplexing filter circuit module 332 includes N sub-channel demultiplexing filters (i.e., sub-channel demultiplexing filters 332_1, 332_2, . . . , 332_N). The N sub-channel demultiplexing filters receive the N CWDM group channels in a one-to-one manner, each of the sub-channel demultiplexing filters is configured to separate each of the CWDM group channels into M recovered sub-channel light signals corresponding to the M sub-wavelength channel locations. It shall be noted that when the sub-wavelength channel locations drift due to a change in the environmental temperature, since there is a fixed wavelength spacing between the M sub-wavelength channel locations at the transmitter, the entire set of the wavelengths of the sub-wavelength channels in each of the CWDM group channels are changed by the same proportion. Therefore, the sub-channel demultiplexing filters of the present embodiment have a wavelength-adjustable function, so that each of the sub-channel demultiplexing filters can still track the M sub-wavelength channel locations in each of the CWDM group channels and adjust central wavelength locations of the filters one by one through the wavelength-adjustable function to perform a correct channel selection.

The light reception module 333 includes N optical receivers (i.e., optical receivers 333_1, 333_2, . . . , 333_N). The N optical receivers are coupled to the N sub-channel demultiplexing filters in the sub-channel demultiplexing filter circuit module 332 in a one-to-one manner to respectively receive the M recovered sub-channel light signals of the corresponding sub-channel demultiplexing filters.

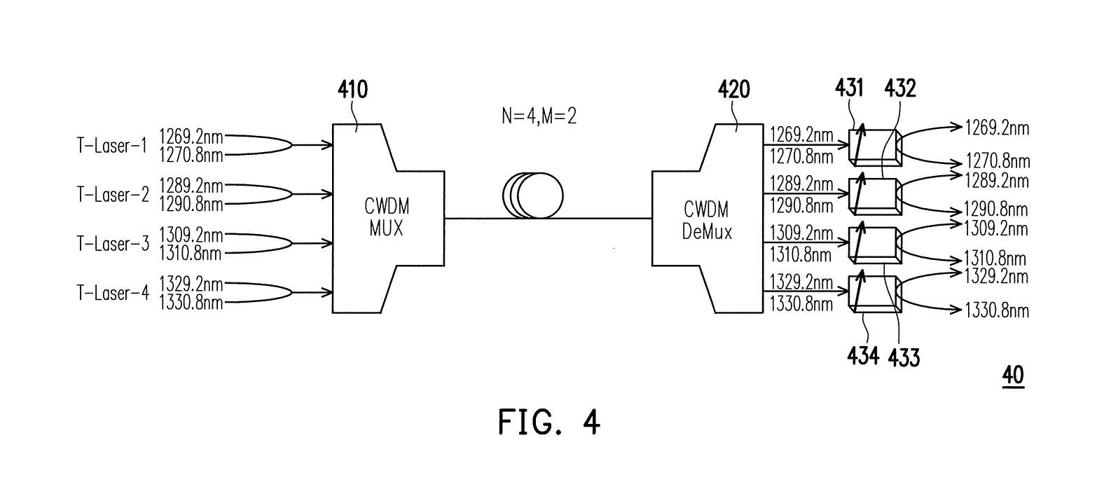

For a clearer understanding of the invention, an applied situation embodiment is provided below to further describe the optical communication system of the present embodiment of the invention. Referring to FIG. 4, FIG. 4 is a schematic diagram illustrating an optical communication system including dual-wavelength laser sources according to an embodiment of the invention.

In the present embodiment, FIG. 4 illustrates a system framework diagram of an example optical communication system including 4 laser source arrays each of which is a dual-wavelength laser source (i.e., N=4 and M=2) according to FIG. 3. As shown in FIG. 4, an optical communication system 40 uses a dual-wavelength laser source array at each of channel locations of 4 CWDM channels (i.e., channel locations of 1270, 1290, 1310, and 1330 nm) in the commonly used 1310 wave band (i.e., N=4 and M=2). Each of the dual-wavelength laser source arrays respectively outputs 2 sub-channel light sources having a smaller wavelength spacing than that of the CWDM channels.

Specifically, a first dual-wavelength laser source array T-Laser-1 outputs 2 sub-channel light sources having a channel wavelength spacing of 1.6 nm at a channel location of 1270 nm of a first CWDM channel (i.e., at channel locations having wavelengths of 1269.2 nm and 1270.8 nm). A second dual-wavelength laser source array T-Laser-2 outputs 2 sub-channel light sources having a channel wavelength spacing of 1.6 nm at a channel location of 1290 nm of a second CWDM channel (i.e., at channel locations having wavelengths of 1289.2 nm and 1290.8 nm). A third dual-wavelength laser source array T-Laser-3 outputs 2 sub-channel light sources having a channel wavelength spacing of 1.6 nm at a channel location of 1310 nm of a third CWDM channel (i.e., at channel locations having wavelengths of 1309.2 nm and 1310.8 nm). A fourth dual-wavelength laser source array T-Laser-4 outputs 2 sub-channel light sources having a channel wavelength spacing of 1.6 nm at a channel location of 1330 nm of a fourth CWDM channel (i.e., at channel locations having wavelengths of 1329.2 nm and 1330.8 nm).

Next, the sub-channel light sources outputted by each of the dual-wavelength laser source arrays are, for example, first exported by the sub-channel couplers (i.e., the sub-channel couplers 312_1, 312_2, . . . , 312_4) shown in FIG. 3 into a same output port. Then, a CWDM multiplexer (CWDM MUX) 410 combines output signals of each of the dual-wavelength laser source arrays into a light signal and guides the light signal into the optical fiber for transmission.

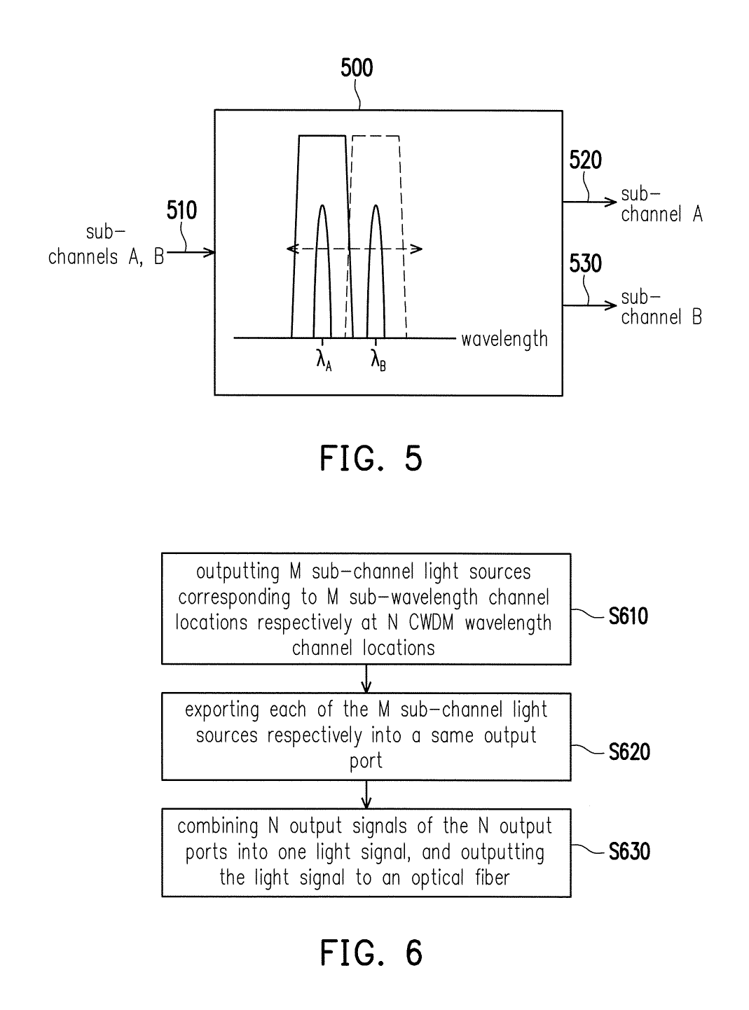

When the light signal is transmitted to the receiver via the optical fiber, the receiver first divides the light signal into 4 sets of CWDM group channels through a CWDM demultiplexer (CWDM DeMux) 420. Then, sub-channel demultiplexing filters 431, 432, 433, 434 separately receive and process signals of each set of the CWDM group channels. It shall be noted that in the present embodiment, the sub-channel demultiplexing filters 431, 432, 433, 434 are one-to-two components and have a wavelength-adjustable function. Reference may be made to a filter shown in FIG. 5 for details).

Referring to FIG. 5, FIG. 5 is a schematic diagram illustrating the sub-channel demultiplexing filter according to FIG. 4. The sub-channel demultiplexing filter 500 includes an input port 510 and two output ports 520, 530. When two sub-channels A, B associated with any one set of the CWDM channels enter the sub-channel demultiplexing filter 500 via the input port 510, the sub-channel demultiplexing filter 500 separates the two sub-channels A, B into the two output ports 520, 530. Moreover, if wavelengths of the sub-wavelength channels A, B drift due to a change in the environmental temperature, the sub-channel demultiplexing filter 500 can still respectively track wavelength locations of the two sub-channels A, B and move central wavelength locations (e.g., at wavelength location λ_{A} or λ_{B} shown in FIG. 5) to execute the wavelength-adjustable function and perform the correct channel selection. It shall be noted that since there are several types of filters that can achieve this function in actual applications, the invention does not limit the sub-channel demultiplexing filter 500 of the present embodiment. Moreover, a spectral response of the sub-channel demultiplexing filter 500 of the present embodiment may be periodic or non-periodic. On this basis, the sub-channel demultiplexing filters 431, 432, 433, 434 of the optical communication system 40 of FIG. 4 perform channel division through adopting the sub-channel demultiplexing filter 500 shown in FIG. 5 to extract 8 channel signals and complete recovery of the signals.

In brief, the optical communication system 40 of the invention adopts only 4 CWDM wavelength channels but actually achieves a transmission capacity of 8 channels. It not only combines advantages of both CWDM and DWDM, but also improves a transmission bandwidth (or capacity) in one single optical fiber. Moreover, it is also not necessary to control a temperature or control a wavelength of the light sources in the optical communication system 40 of the invention, which additionally lowers maintenance costs.

FIG. 6 is a flowchart illustrating a multi-channel optical transmission method according to an embodiment of the invention. First, in step S610, M sub-channel light sources corresponding to M sub-wavelength channel locations are respectively outputted at N CWDM wavelength channel locations. Moreover, a wavelength spacing between the M sub-wavelength channel locations is smaller than a wavelength spacing between the N CWDM wavelength channel locations. In addition, there is a fixed wavelength spacing between the M sub-wavelength channel locations. Then, in step S620, each of the M sub-channel light sources is respectively exported into a same output port. Next, in step S630, N output signals of the N output ports are combined into a light signal, and the light signal is outputted to an optical fiber.

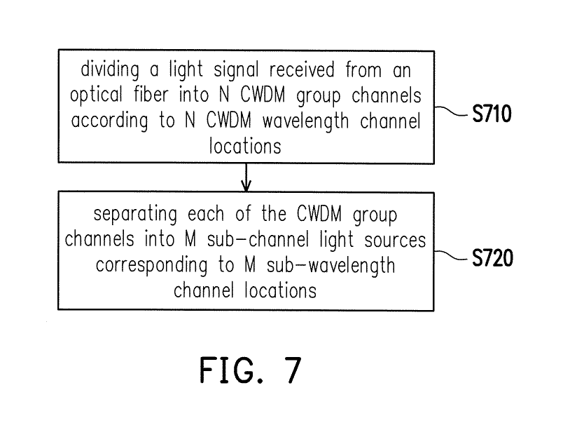

FIG. 7 is a flowchart illustrating a multi-channel optical reception method according to an embodiment of the invention. First, in step S710, a light signal received from an optical fiber is divided into N CWDM group channels according to N CWDM wavelength channel locations. Then, in step S720, each of the CWDM group channels is separated into M sub-channel light sources corresponding to M sub-wavelength channel locations. There is a fixed wavelength spacing between the M sub-wavelength channel locations.

It shall be noted that steps S610 to S630 may correspond to the transmitter 310 of the optical communication system 30 of FIG. 3, and steps S710 to S720 may correspond to the receiver 330 of the optical communication system 30 of FIG. 3. The details of each step have been described in the foregoing embodiments and shall not be repeated here.

In summary of the above, the embodiments of the invention provide an optical communication system and multi-channel optical transmission and reception methods. In the transmitter of the optical communication system, a plurality of light sources of different wavelengths close to one single CWDM channel are packaged into one single carrier or are integrally manufactured on one single substrate, so that they exhibit similar amounts of wavelength drift with respect to a change in the environmental temperature without having to control a temperature. Moreover, the receiver of the optical communication system adopts the filters that can track wavelength locations. Accordingly, when a wavelength drift arises in each of the wavelength channels due to influence of the environmental temperature or component performance aging, the signals can still be effectively demultiplexed and respectively received. Hence, by enabling the channel locations at the original CWDM, the optical communication system of the invention increases a number of channels that can actually be transmitted and a capacity of data that can be transmitted. Moreover, while the advantage that it is not necessary to control the temperature of the CWDM channel light sources is maintained, complexity of transceiving modules is significantly simplified and manufacturing and maintenance costs are lowered.

Although the invention is disclosed as the embodiments above, the embodiments are not meant to limit the invention. Any person skilled in the art may make slight modifications and variations without departing from the spirit and scope of the invention. Therefore, the protection scope of the invention shall be defined by the claims attached below.

What is claimed is:

1. An optical communication system comprising:
a transmitter and a receiver, wherein the transmitter comprises:
N laser source arrays, wherein each of the laser source arrays corresponds to a CWDM wavelength channel location and outputs M sub-channel light sources corresponding to M sub-wavelength channel locations at the CWDM wavelength channel location, wherein M is a natural number of at least 2;
N sub-channel couplers, wherein the N sub-channel couplers are coupled to the N laser source arrays in a one-to-one manner, and each of the sub-channel couplers respectively receives the M sub-channel light sources corresponding to the laser source array and exports the M sub-channel light sources into a same output port; and
a CWDM multiplexer coupled to each of the sub-channel couplers to receive an output signal of each of the sub-channel couplers, to combine the N output signals into a light signal, and to output the light signal to an optical fiber, and
the receiver comprises:
a CWDM demultiplexer receiving the light signal from the optical fiber, and dividing the light signal into N CWDM group channels according to the N CWDM wavelength channel locations; and
N sub-channel demultiplexing filters, wherein each of the sub-channel demultiplexing filters is coupled to the CWDM demultiplexer, the N sub-channel demultiplexing filters receive the N CWDM group channels in a one-to-one manner, and each of the sub-channel demultiplexing filters is configured to separate one of the CWDM group channels into M recovered sub-channel light signals corresponding to the M sub-wavelength channel locations.

2. The optical communication system according to claim 1, wherein a wavelength spacing between the M sub-wavelength channel locations is smaller than a wavelength spacing between the N CWDM wavelength channel locations.

3. The optical communication system according to claim 1, wherein there is a fixed wavelength spacing between the M sub-wavelength channel locations.

4. The optical communication system according to claim 1, wherein the M sub-wavelength channel locations of the transmitter drift due to a change in an environmental temperature, and the corresponding sub-channel demultiplexing filters of the receiver are further configured to:
track the M sub-wavelength channel locations in the CWDM group channels and individually or collectively adjust central wavelength locations to the M sub-wavelength channel locations, and
separate the CWDM group channels into the M recovered sub-channel light signals corresponding to the M sub-wavelength channel locations.

5. The optical communication system according to claim 4, further comprising:
N optical receivers, wherein the N optical receivers are coupled to the N sub-channel demultiplexing filters in a one-to-one manner, and each of the optical receivers respectively receives the M recovered sub-channel light signals corresponding to the sub-channel demultiplexing filter.

6. A multi-channel optical transmission method applicable to an optical communication system, the multi-channel optical transmission method comprises:
outputting M sub-channel light sources corresponding to M sub-wavelength channel locations respectively at N CWDM wavelength channel locations, wherein M is a natural number of at least 2;
exporting each of the M sub-channel light sources respectively into a same output port; and
combining N output signals of the N output ports into a light signal, and outputting the light signal to an optical fiber.

7. The multi-channel optical transmission method according to claim 6, wherein a wavelength spacing between the M sub-wavelength channel locations is smaller than a wavelength spacing between the N CWDM wavelength channel locations.

8. The multi-channel optical transmission method according to claim 6, wherein there is a fixed wavelength spacing between the M sub-wavelength channel locations.

9. A multi-channel optical reception method applicable to an optical communication system, the multi-channel optical reception method comprises:
dividing a light signal received from an optical fiber into N CWDM group channels according to N CWDM wavelength channel locations; and
separating each of the CWDM group channels into M sub-channel light sources corresponding to M sub-wavelength channel locations,
wherein M is a natural number of at least 2, and there is a fixed wavelength spacing between the M sub-wavelength channel locations.
